(19) United States
(12) Patent Application Publication
(10) Pub. No.: US 2014/0278344 A1
(43) Pub. Date: Sep. 18, 2014

(54) ENGLISH TRAINING METHOD AND DEVICE

(71) Applicant: Yunfei XIAO, Flushing, NY (US)

(72) Inventor: Yunfei XIAO, Flushing, NY (US)

(21) Appl. No.: 14/202,604

(22) Filed: Mar. 10, 2014

(30) Foreign Application Priority Data
Mar. 15, 2013 (CN) 201310084532.3

(51) Int. Cl. G09B 19/06; G06F 17/28

(52) U.S. Cl. CPC G09B 19/06; G06F 17/28
USPC 704/2

(57) ABSTRACT

The present disclosure provides an English training method, including the following steps: classifying and storing words according to predetermined word classification rules; receiving a user command for extracting a corresponding word according to a classification of the word, and extracting the corresponding word according to the user command and outputting the word in audio or video form; the word classification rules including: combining two consonants with five vowels a, e, i, o, and u respectively to form words; or using a main word or a transformation of the main word as a main body, and combining the main body with 26 letters of the English alphabet in sequence to form words; or combining the five vowels a, e, i, o, and u with other letters of the English alphabet to form word roots, and combining each of the word roots with the 26 letters of the English alphabet in sequence to form words; or matching a whole English sentence or a whole English paragraph with a Chinese song; or noting a pronunciation of the word in the English sentence by Chinese.

### BACKGROUND

1. Technical Field

The present invention relates to computing technologies, and particularly, to an English training method and an English training device.

2. Description of Related Art

People in China have been researching how to learn English well for a long time. Based on this, researchers have made a number of studies to summarize various kinds of studying methods. Researchers have even designed training and education systems specialized in English training, such as the well-sold training device for pronunciation of spoken English in market. These training and education systems can output audio information or video information to guide people to synchronously study English. However, at present, most of the training and education systems are based on teaching material, and the audio information or video information outputted therefrom was synchronous with the teaching material being pointed to special sentences or words. Thus, the trainees are required to understand the contents of the teaching material for keeping up with the teaching progress, which causes the training and education systems are not applicable to the users without the teaching material.

### SUMMARY

The object of the present disclosure is to provide an English training method for overcoming above-mentioned problems.

The English Mining method of the present disclosure includes:

classifying and storing words according to predetermined word classification rules; and

receiving a user command for extracting a corresponding word according to a classification of the word, and extracting the corresponding word according to the user command and outputting the word in audio or video form;

the word classification rules includes:

combining two consonants with five vowels a, e, i, o, and u respectively to form words; or

using a main word or a transformation of the main word as a main body, and combining the main body with 26 letters of the English alphabet in sequence to form words; or

combining the five vowels a, e, i, o, and u with other letters of the English alphabet to form word roots, and combining each of the word roots with the 26 English letters of the English alphabet in sequence to form words; or

matching a whole English sentence or a whole English paragraph with a Chinese song; or

noting a pronunciation of the word in the English sentence by Chinese.

Preferably, the step of combining two consonants with five vowels a, e, i, o, and u respectively to form words includes:

searching a database to determine whether the formed word has a basic meaning or not; if the formed word does not have a basic meaning, adding at least one letter to the formed word or modifying at least one letter of the formed word to obtain a new word having a basic meaning.

Preferably, the step of matching a whole English sentence or a whole English paragraph with a Chinese song includes:

connecting the whole English sentence or the whole English paragraph by Chinese characters to form a story.

Preferably, the step of using a main word or a transformation of the main word as a main body, and combining the main body with 26 letters of the English alphabet in sequence to form words includes:

if the letter combined with the main body is a vowel, adding a consonant behind the vowel before the vowel is combined with the main body.

Preferably, the step of matching a whole English song or a whole English paragraph with a Chinese song includes:

matching a same melody with different tense words.

The present disclosure further provides an English training device, including:

a word classification module, being configured for classifying and storing words according to predetermined classification rules;

a user command processing module, being configured for receiving a user command for extracting a corresponding word according to a classification of the word, and extracting the corresponding word according to the user command and outputting the word in audio or video form;

the word classification rules includes:

combining two consonants with five vowels a, e, i, o, and u respectively to form words; or

using a main word or a transformation of the main word as a main body, and combining the main body with 26 letters of the English alphabet in sequence to form words; or

combining the five vowels a, e, i, o, and u with other letters of the English alphabet to form word roots, and combining each of the word roots with the 26 English letters of the English alphabet in sequence to form words; or

matching a whole English sentence or a whole English paragraph with a Chinese song; or

noting a pronunciation of the word in the English sentence by Chinese.

Preferably, the word classification module is further configured for:

searching a database to determine whether the formed word has a basic meaning, and adding at least one letter to the formed word or modifying at least one letter of the formed word to obtain a new word having a basic meaning if the formed word does not have a basic meaning.

Preferably, the word classification module is further configured for:

connecting the whole English sentence or the whole English paragraph by Chinese characters to form a story.

Preferably, the word classification module is further configured for:

adding a consonant behind the vowel before the vowel is combined with the main body if the letter combined with the main body is a vowel.

Preferably, the word classification module is further configured for:

matching a same melody with different tense words.

The present disclosure classifies and integrates English words according to predetermined rules, extracts the corresponding English word according to the user command and outputs the extracted English word in audio or video form according to the classification of the word, which allows the user to learn English without teaching material, simplifies the teaching process, and enlarges the ranges of the educated people. Furthermore, the classification rule is simple and easy to learn, thereby improving the teaching efficiency.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a tree view showing classifications of English words.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

The present disclosure provides an English training method, which includes the following steps:

classifying and storing words according to predetermined word classification rules;

receiving a user command for extracting a corresponding word according to a classification of the word, and extracting the corresponding word according to the user command and outputting the word in audio or video form;

the word classification rules includes:

combining two consonants with five vowels a, e, i, o, and u respectively to form words; or

using a main word or a transformation of the main word as a main body, and combining the main body with the 26 English letters in sequence to form words; or

combining the five vowels a, e, i, o, and u with other letters of the English alphabet to form word roots, and combining each of the word roots with the 26 English letters in sequence to form words; or

matching a whole English sentence or a whole English paragraph with a Chinese song; or

noting a pronunciation of the word in the English sentence by Chinese.

In the present disclosure, a digital processing device such as a computer, which includes a storage module, an audio/video outputting module, and a central processing module, can be provided to allow the user to preset the word classification rules in program forms and further provided to classify and storage the words by executing the programs. After the user command for extracting the words according to the classifications of the words is received, the words of the same classification are extracted from the storage module. For example, a selection box which allows the user to select the way of extracting the words can be provided in the user interface. After the user select the way of extracting the words, the central processing module extracts the words of the same classification and outputs the words.

Specifically, the classification rule of combining two consonants with five vowels a, e, i, o, and u respectively to form the words includes adding the five vowels (including a, e, i, o, and u) respectively between the two consonants to respectively form five words and distinguishing the pronunciations of the consonants relative to the five vowels. Since the pronunciations of more than ninety percent of the English words or syllables are based on sub-syllables formed by the five vowels, if people can be familiar with the pronunciations of the sub-syllables, blurt the pronunciation of the corresponding sub-syllable out without much thinking, and get into the habit of altering pronunciations naturally, people then can pronounce the words accurately without learning phonetic symbols (PS: to people without any English foundation, the above situation can save their time; particularly, it is difficult for adults to change their accents at their ages, for example, it is difficult for an Chinese adult with a regional accent to learn standard mandarin and get rid of the regional accent, thus, people may lose confidence if they cannot make standard pronunciations of the phonetic symbols after studying the pronunciations for about half a year to one year).

In the above embodiments, if the five vowels are added to the following consonants, people can write the words correctly by reading the words over and over again. More importantly, if the pronunciations of the words can be made by in happy songs which have won universal praise, the words can be sung out without much thinking and finally can be pronounced accurately.

The magic of adding the two consonants with the five vowels lies in that, five words can be learned and kept in mind by writing five “p t” continuously and adding the five vowels between “p” and “t” respectively. The other examples also can work like this. The followings are examples showing that words are formed by adding the five vowels between the two consonants respectively.

### Example One

| English word | Chinese translation represented by Pinyin |
|---|---|
| Pat | paida |
| Pet | chongwu |
| Pit | kengdong |
| Pot | guo |
| Put | tuidong |

There is a Chinese song for remembering the above words with the pronunciation of the corresponding word (including pat, pet, pit, pot, and put) represented by Pinyin being in the parenthesis following the corresponding word:

Pat (pai te) pate (pai te) shi paida, qianwan bie wangji,

Pet (pai (ai) te) pet (pai (ai) te) shi chongwu, women yao baohu ta,

Pit (pei te) pit (pei te) shi kengdong, qianwan bie diaoxiaqu,

Pot (pao (ao) te) pot (pao (ao) te) shi guo er,

Put (pu te) shi tuidong;

A pet (pai (ai) te) pats (pai te) and puts (pu te) a pot (pao (ao) te) into a Pit (pei te);

Pat (pai te) pate (pai te) shi paida, qianwan bie wangji,

Pet (pai (ai) te) pet (pai (ai) te) shi chongwu, women yao baohu ta,

Pit (pei te) pit (pei te) shi kengdong, qianwan bie diaoxiaqu,

Pot (pao (ao) te) pot (pao (ao) te) shi guo er,

Put (pu te) shi tuidong.

### Example Two

| English word | Chinese translation represented by Pinyin |
|---|---|
| Last | zuihou, mowei |
| Lest | weikong |
| List | liebiao, qingdan |
| Lost | shiluo |
| Lust | yuwang |

### Example Three

| English word | Chinese translation represented by Pinyin |
|---|---|
| Rack | xingli jia |
| Reck | gulv |
| Rick | like (nanzi mingzi) |
| Rock | yaogun, shitou |
| Ruck | lake (nanzi mingzi) |

### Example Four

| English word | Chinese translation represented by Pinyin |
|---|---|
| Nat | nate (nanzi mingzi), sugelan huozhe |
| | weiershi de minzu zhuyizhe |
| Net | wangluo, jingli, shijia |
| Nit | youchong, mei yong de ren |
| Not | bu (yongyu foudingju) |
| Nut | luomu, jianguo, nan duifu de ren |

### Example Five

| English word | Chinese translation represented by Pinyin |
|---|---|
| Band | yuedui |
| Bend | wanqu |
| Bind | bang |
| Bond | zhaiquan |
| Bund | tifang |

### Example Six

| English word | Chinese translation represented by Pinyin |
|---|---|
| Pack | baozhuang, yiqun, beibao |
| Peck | xuduo, peike, zhuohen |
| Pick | tiaoxuan, caizhai, shiqu |
| Pock | douhen, mazi |
| Puck | bingqiu |

### Example Seven

| English word | Chinese translation represented by Pinyin |
|---|---|
| Ball | qiu, wuhui |
| Bell | ling, zhong, lingsheng, zhongsheng |
| Bill | bi-er |
| Boll | yuanjia, bo-er |
| Bull | gongniu |

### Example Eight

| English word | Chinese translation represented by Pinyin |
|---|---|
| Sat | zuo |
| Set | zhuangzhi |
| Sit | jiuzuo |
| Sot | zuigui |
| SUT | bei ceshi de xitong |

### Example Nine

| English word | Chinese translation represented by Pinyin |
|---|---|
| Hat | maozi |
| Het | zhongxing shebei yunshuche |
| Hit | daji, chenggong, fengci |
| Hot | re, reqing de, jidong de |
| Hut | xiaowu, linshi yingfang |

### Example Ten

| English word | Chinese translation represented by Pinyin |
|---|---|
| Saw | juzi, yanyu |
| Sew | fenghe, fengren |
| Siw | zishang |
| Sow | bozhong, sanbu, mibu |
| Sue | konggao, qingqiu |

### Example Eleven

| English word | Chinese translation represented by Pinyin |
|---|---|
| Band | yuedui, songjingdai, and chuansongdai |
| Bend | wanqu, qufu, and chaoxiang |
| Bind | kunbang, kunjing, taoyan de shiqing, and |
| | zhiwu de tengman |
| Bond | zhaiquan, jiehe, and zhanheji |
| Bund | di-an, matou, and tongmeng |

In another embodiment of the present disclosure, combining two consonants with the five vowels a, e, i, o, and u respectively to form words can further include:

searching a database and judging whether the formed word has a basic meaning, if the formed word does not have a basic meaning, adding at least one letter to the formed word or modifying at least one letter of the formed word to obtain a new word which has a basic meaning.

In a first example, the new word having a basic meaning can be formed by modifying one letter of the formed word without a basic meaning or adding one letter to the formed word without a basic meaning. For example, five words including bad, bed, bid, bod, and bud can be formed by placing the five vowels between two consonants respectively, such as between the consonant b and the consonant d. Among the five words, “bod” is wrong word but can be changed to “body” by adding the letter “y” of the English alphabet thereafter, which means “shenti” (represented by Pinyin) in Chinese. The followings are several groups of words showing that a new word having a basic meaning is formed by modifying one letter of the formed word or by adding one letter of the English alphabet to the formed word without a basic meaning.

### Group One:

| English word | New word | Chinese translation represented by Pinyin |
|---|---|---|
| Bad | | huai de |
| Bed | | chuang |
| Bid | | jingbiao |
| Bod | Body | shenti |
| Bud | | hualei |

### Group Two:

| English word | New word | Chinese translation represented by Pinyin |
|---|---|---|
| Bane | | duyao, huohai |
| Bene | | qidao, xinjineiya de yezhu |
| Bine | | huai de |
| Bone | | guge, xiangyan, yishouge |
| Bune | Bung | saizi |

### Group Three:

| English word | New word | Chinese translation represented by Pinyin |
|---|---|---|
| Rase | | huai de |
| Rese | Reuse | chongxin shiyong |
| Rise | | shangsheng |
| Rose | | meigui |
| Ruse | | guiji, celve |

### Group Four:

| English word | New word | Chinese translation represented by Pinyin |
|---|---|---|
| Back | | houmian |
| Beck | | zhaoshou |
| Bick | Bicky | binggan |
| Bock | | yibei pijiu |
| Buck | | yuan |

### Group Five:

| English word | New word | Chinese translation represented by Pinyin |
|---|---|---|
| Batter | | jiqiushou |
| Better | | zhangbei |
| Bitter | | kude |
| Botter | Bother | darao, mafan |
| Butter | | huangyou |

### Group Six:

| English word | New word | Chinese translation represented by Pinyin |
|---|---|---|
| Lane | | xiaoxiang, hangxian, chedao, faqiuqu |
| Lene | Lend | jiechu, daikuan |
| Line | | luxian, hangxian, sheng |
| Lone | | danshende, duzide, jimode |
| Lune | | gongxing |

### Group Seven:

| English word | New word | Chinese translation represented by Pinyin |
|---|---|---|
| Lat | | weidu, jiexian, huodong fanwei |
| Let | | yunxu, rang, jiashe, chuzu |
| Lit | | zhaoliangde, dianzhaode |
| Lot | | mingyun, yikuaidi, chouqian |
| Lut | Lute | luteqin, fengni |

### Group Eight:

| English word | New word | Chinese translation represented by Pinyin |
|---|---|---|
| Mast | | weigan, xiangshu guoshi |
| Mest | Meat | rou |
| Mist | | baowu, mohubuqing |
| Most | | dabufende, duoshude, zuiduode |
| Must | | bixu, yiding, keyi |

### Group Nine:

| English word | New word | Chinese translation represented by Pinyin |
|---|---|---|
| Pag | Page | yemian, jilu, dashijian, nanshizhe |
| Peg | | ding, zhuang, jiekou, zizibujuan |
| Pig | | zhu, zhurou, jiangcha |
| Pog | Pogo | tanhuang dan gaoqiao |
| Pug | | habagou, shizibi, niliao, jiaoyin |

### Group Ten:

| English word | New word | Chinese translation represented by Pinyin |
|---|---|---|
| Rat | | laoshu, beibixiaoren, pantu |
| Ret | | jinshuishirouruan, shouchaoshifulan |
| Rit | Rite | yishi, guanli, xisu |
| Rot | | fulan, fubai, fuhuai |
| Rut | | faqingqi, guanli, xingchongdong |

### Group Eleven:

| English word | New word | Chinese translation represented by Pinyin |
|---|---|---|
| Shap | Shape | xingzhuang, muxing, shencai |
| Shep | Sheep | yang, danxiaogui |
| Ship | | chuan, jian |
| Shop | | shangdian |
| Shup | Shut | zhukou, guanbi |

### Group Twelve:

| English word | New word | Chinese translation represented by Pinyin |
|---|---|---|
| Hap | | ouranfasheng |
| Hep | | xiaoxilingtongde, shuzhide |
| Hip | | tunbu, pigu, yaogu |
| Hop | | tiaoyue, qifei |
| Hup | Hub | zhongxin |

In a second example, the new word which has a basic meaning can be formed by modifying two letters of the formed word without a basic meaning or adding two letters of the English alphabet to the formed word without a basic meaning. The followings are several groups of words showing that a new word having a basic meaning is formed by modifying two letters of the formed word or by adding two letters to the formed word.

### Group One:

| English word | New word | Chinese translation represented by Pinyin |
|---|---|---|
| Sat | | zuo |
| Set | | jihe, yitao, zhuangzhi |
| Sit | | zuo |
| Sot | | zuigui, xujiuzhe |
| Sut | Sutra | fojing |

### Group Two:

| English word | New word | Chinese translation represented by Pinyin |
|---|---|---|
| Tap | | qingqiao |
| Tep | Tepid | weiwen de |
| Tip | | xiaofei |
| Top | | dingbu |
| Tup | | gongyang |

### Group Three:

| English word | New word | Chinese translation represented by Pinyin |
|---|---|---|
| Past | | guoqu, wangshi |
| Pest | | haichong, taoyan de ren |
| Pist | Pistol/Pison/ | shouqiang/huosai/huoxuedao/qiancheng de |
| | Piste/Piety | |
| Post | | gangwei, youjian, biaogan |
| Pust | Pustule | nongbao |

### Group Four:

| English word | New word | Chinese translation represented by Pinyin |
|---|---|---|
| Rap | | qiangzou, qingqiao, zhaomi |
| Rep | | lengwenpingbu, leipu |
| Rip | | liekai, silie |
| Rop | Rope | shengsuo |
| Rup | Rupee | lubi (huobi danwei) |

In a third example, the new word having a basic meaning is formed by modifying three letters of the formed word without a basic meaning or by adding three letters to the formed word without a basic meaning. The followings are several groups of words showing that a new word is formed by modifying three letters of the formed word or by adding three letters to the formed word.

### Group One:

| English word | New word | Chinese translation represented by Pinyin |
|---|---|---|
| Pake | Pakistan | bajisitan |
| Peke | Peking | beijing |
| Pike | | tongxingfei, mao, suoziyu, jiantou, |
| | | shoufeidaolu |
| Poke | | ganshe |
| Puke | | outu |

### Group Two:

| English word | New word | Chinese translation represented by Pinyin |
|---|---|---|
| Wat | Water | shui |
| Wet | | yutian, shiqi |
| Wit | | zhihui, caizhi, zhili |
| Wot | Would | jiangyao, yuanyi |
| Wut | Wuzzle | hunhe, gaohun |

In an embodiment of the present disclosure, using a main word or a transformation of the main word as a main body, and combining the main body with the 26 letters of the English alphabet in sequence to form words includes:

if the letter of the English alphabet combined with the main body is a vowel, adding a consonant behind the vowel before the vowel is combined with the main body.

In a first example, the main body is ear.

When the word is formed by combining one of the 26 letters of the English alphabet with the main body, or is formed by combining app being pronounced as Pinyin “a pi”, en being pronounced as Pinyin “yi”, br being pronounced as Pinyin “bo rui”, cl being pronounced as Pinyin “ke le”,dr being pronounced as Pinyin “zhuai”, fl being pronounced as Pinyin “fu le”, gr being pronounced as Pinyin “ge rui”, in being pronounced as Pinyin “yin”, it being pronounced as Pinyin “ai rui”, kn being pronounced as Pinyin “ne”, on being pronounced as Pinyin “ang”, qu being pronounced as Pinyin “kuai”, re being pronounced as Pinyin “rui”, un bein pronounced as Pinyin “an”, wh being pronounced as Pinyin “wu” or “he”, or exp being pronounced as Pinyin “ai ke po” with the main body, the pronunciation can be directly made by adding the pronunciation of the word or the root.

There is exception in any pronunciation, for example, when ear (being pronounced as Pinyin “yi er”) is combined with b, p, w, sw, the pronunciation of ear will become Pinyin “ai er”, therefore:

bear (means “xiong” (represented in Pinyin) in Chinese, pronounced as Chinese Pinyin “bai er”) cannot be pronounced the same as the word beer (means “pijiu” in Chinese, prounuced as Pinyin “bi er”);

pear (means “li” in Chinese, pronounced as Pinyin “pai er”) cannot be pronounced the same as the word peer (means “toukan” in Chinese, pronounced as Pinyin “pi er”);

wear (means “chuangdai” in Chinese, pronounced as Pinyin “wei er”) cannot be pronounced the same as the word weigher (means “chenhuoyuan” in Chinese, pronounced as Pinyin “wei er”); and

swear (means “fashi” in Chinese, pronounced as Pinyin “shi wai er”) cannot be pronounced as Pinyin “shi wei er”.

Remarks: in order to make the leaner to remember the words easily, a “_” can be added at the bottom of the words such as bear, pear, wear, swear, etc, to indicate that the word root ear in the words is pronounced as Pinyin “ai er”.

English pronunciation rule is in common with the law of life in many aspects, for example, homosexuality and bisexuality exit in human, also homosexuality and bisexuality exit in English words. For example, two vowels originally cannot be spelt together, while in the words including aasvogel, aardvark, aardwolf, two vowels are spelt together to become homosexual vowels. T and t are spelt together to be homosexual. When “T” and “ear” are spelt together to mean “yanlei” and “liulei” (represented by Pinyin) in Chinese, ear is pronounced normally as “yi er”, thus, tear is pronounced as “ti er”, for example:

his speech moved us to tears (Chinese translation represented by Pinyin: ta de yanshuo rang women gandong de liulei); and

she bursts into tears (Chinese translation represented by Pinyin: ta turan kule qilai).

When the word tear means “si dongxi” in Chinese, the pronunciation thereof becomes Pinyin “tai ai er”, for example:

he tears a letter into half (Chinese translation represented by Pinyin: ta ba xin si cheng le liangban); and

she tears a hole in her coat (Chinese translation represented by Pinyin: ta ba ta de dayi si le yige dong).

Remarks: when tear is normally pronounced as Pinyin “ti yi er” with the meaning thereof being “liulei” in Chinese, a line can be added under the word and a number 1 can be simultaneously added behind the word—tear¹ for indicating the pronunciation of the word; when tear is pronounced as Pinyin “taier”, a line can be added under the word and a number 2 can be simultaneously added behind the word—tear² for indicating the pronunciation of the word.

The followings are words including the main body ear with the transformation thereof being eer or ire:

| | Pronunciation | Chinese translation |
|---|---|---|
| English word/phrase | represented by Pinyin | represented by Pinyin |
| appear | a pi er | chuxian |
| bear | bai er | xiong, chengdan |
| clear | ke li er | qingjie, ganjing |
| dear | di er | qin-aide |
| drear | zhuai er | yanjuande, yinchende |
| ear | yi er | erduo |
| earn | e n | ying |
| early | e li | zao |
| earth | e si | diqiu |
| fear | fei er | haipa |
| fearless | fei er lv shi | wuju, wuwei |
| gear | gei er | jiasu |
| hear | hei er | tingjian |
| idea (with the | ai di er | zhuyi, guannian |
| omission of r) | | |
| jeer | ji er | jixiao |
| korea (with the | ke rui er | hanguo |
| omission of r) | | |
| lear | li er | xuewen, zhishi |
| learn | le e n | xuexi |
| mere (Special form) | mi er | zhibuguo, chitang |
| near | nie er | fujin |
| on earth | ang e si | shi, quanqiu |
| pear | pai er | li |
| queer | | nantongxinglian, pohuai, |
| | | shikunjing |
| rear | rui er | houmian, beihoude |
| research | sui se er qi | diaocha, yanjiu |
| sear | se er | shao, kuwei |
| search | se er qi | xunzhao |
| tear | ti er | liulei |
| tear | tai er | sisui |
| unweary | ang wei er rui | bupijuande, weiyanfande |
| unwearied | ang wei er de | buquburaode, |
| | | zizibujuande |
| unfearing | ang fei er rui | buweijude |
| where (special form) | wei er | na-er |
| wear | wai er | chuan, dai |
| swear | si wai er | fashi, maren |
| veer | wei er | zhuanxiang |
| expire | ai ke si bai er | zhongzhi, tuqi |
| year | yi er | nian |
| yearn | yi e | simian |
| Zebra (special form) | ri bu ruo | banma |

If the words listed above are combined to form familiar music (such as the song Shu Lai Bao in Chinese), people can remember these words easily and happily. For example, the music showing the combination of the word root ear and other letters can be as follows (represented by Pinyin): shu lai bao, ba bao lai shu, kuai le ging song ying yu ji yi shi yi bao; jin tian bu ba bie de li zi ju, dan shuo ying yu dan ci ear (EAR)-er de fa yin he zu he; ying yu de er duo jiao yi er de fa yin he zu he; ying yu de er duo jiao yi er; you EAR (ear) san ge zi mu lai zu cheng; to de fa yin shi yi er, fan cheng zhong wen shi er duo; wei he yao yi bian bian ba zhe EAR (yi er) er duo lai bei shu . . . .

Referring to FIG. 1, in an embodiment of the present disclosure, the words can be classified according to the pronunciations thereof, for example, the words can be labeled according to the pronunciations of the word roots thereof, for example, the pronunciations of most of the words can be labeled as a black trunk 10 (the word root ear being pronounced as Pinyin “yi er”), the pronunciations of few words are labeled as red flowers 30 (the word root eer being pronounced as Pinyin “yi er”) or green leaves 20 (the word root ire being pronounced as Pinyin “ai er”), and the pronunciations of some special words are labeled as special fruits 40. In this way, the pronunciations of the words can be easily remembered by being arranged according to rules, colors and descriptions.

1. appear

2. bear: the letter b of the English alphabet can be analogous to be a beauty and ear can be analogous to be a handsome boy; thus, when ear meets b, the pronunciation of ear is changed from the same as Pinyin “yi er” to be the same as Pinyin “ai er”. In this way, the sound linking of ear with the letter b should be the same as Pinyin “bai er” rather than be the same as Pinyin “bi er”.

3. clear

4. dear

5. ear

If a constant or an associated syllable is added to the end of the word ear to form a new word, the part of the new word behind ear is much more pronounced than ear. That is, ear cannot be pronounced as Piyin “yi er” anymore, but is pronounced as the sound linking of Pinyin “e” and the constant following thereafter or the sound linking of Pinyin “e” and the syllable including a constant and a vowel(s). For example, if a letter n is added to the end of the word ear, the word earn is formed and is pronounced as Pinyin “e en” rather than as Pinyin “yi er en”. For another example, early is pronounced as Pinyin “er li” rather than as Pinyin “yi er li”. Furthermore, the word is pronounced as Pinyin “e si”.

6. fear

7. gear

8. hear

9. idea

10. jeer

11. koear: the word can be remembered in the following way: at first changing the letter combination ok into ko having the pronunciation thereof as that of the letter k; after that, the letter r in ear is moved to the end of ko to form the word korea. The word is proununced as Pinyin “ke run er” and means “chaoxian” (represented by Pinyin) in Chinese.

12. lear-learn

13. (+s)—smear

14. near

15. [opear]: the word has a special pronunciation. The rear-two letters of the letter combination opear can be reversed to form opera with a special pronunciation as Pinyin “ao po ruo” rather than as Pinyin “ou pi er”.

16. pear: suppose the letter p is a beauty and the word ear is a handsome, when the word ear is combined with the letter p, the word pear is formed having a special pronunciation as Pinyin “bi er” rather than as Pinyin “pai er”.

17. queer

18. rear

19. sear: search—search is formed by adding ch to the end of the word sear and is pronounced as Pinyin “se chi”. Search means “xunzhao” (represented by Pinyin) in Chinese. The word research can be formed by adding re in front of the word search to mean“zaizhao, yanjiu” (represented by Pinyin) in Chinese.

a20. tear: when ear is normally pronounced as Pinyin “yi er”, the word tear is pronounced as “ti er” and means “yanlei” (represented by Pinyin) in Chinese.

b20. When ear is pronounced as Pinyin “ai er”, the word tear is pronounced as Pinyin “tai er” and means “silie, yanjuan, kunfa” (represented by Pinyin) in Chinese.

21. unclear: the word unclear is pronounced as Pinyin “an ke li er” and means “buganjing” (represented by Pinyin) in Chinese; if the letters n and u are reversed, the word would be nuclear with the pronunciation thereof as Pinyin “niu ke li er”.

22. veer

23. wear: suppose that the letter w is a sexy girl and ear is a handsome guy, after ear meets w, the word wear is formed having the pronunciation thereof as Pinyin “wai er” and meaning “chuandai” (represented by Pinyin) in Chinese, for example, the phrase “wear glasses” is pronounced as “wai er ge la shi” and means “daiyanjing” (represented by Pinyin) in Chinese.

24. expire

25. year

26. [zear]: the word zear has a special pronunciation; if the letter r is changed to be the letter 1, the word zeal is formed having the pronunciation thereof as Pinyin “ri ai ou” and meaning “reqing” (represented by Pinyin) in Chinese.

### Guessing Riddles

In this paragraph, English together with Chinese homonym as well as relevant analogy are used to allow the learner to guess the meaning of the English word according to the Chinese homonym and the implied meaning. The pronunciation is proofread according to the pronunciation of the part of an old gentleman in Chinese operas, which makes the pronunciations of the English words approachable to western accents. More importantly, the rough Chinese meaning of the English word can be told from the homonym of the corresponding word, thus, the learner can not only remember the pronunciation of the word but also remember the meaning of the word by choosing a, b, c in games or examinations. See the examples in Table One below.

TABLE ONE
example showing learning words by guessing riddles

| | pronounication represented by Pinyin |
|---|---|
| | Chinese translation represented by Pinyin |
| English word/ | choice question reflecting Chinese translation |
| English phrase | of corresponding word represented by Pinyin |
| Arrest in jail | a rui si ting ying jian lao; |
| | daibu dao jianyu; |
| | arrest means: a. daoda, b. zhuahuo, c. jianlao; |
| Best | bai shi de; |
| | zuihao de; |
| | best means: a. yiban de, b. zuihao de, c. buhao de; |
| Crest cock | guan si te kao ke; |
| | jiguan gongji; (kaoke gongji de hong guanzi); |
| | crest means: a. jiguanzi, b. huangguan, c. hongding; |
| Destine died | dai si ting dai de; |
| | mingyun siwang; |
| | destine means: a. xingyun, b. eyun, c. mingyun; |
| East food | ye si ta fu di; |
| | dongfang de shipin; |
| | east means: a. xifang, b. nanfang, c. dongfang; |
| Fest festival | fei si ta wa na; |
| | jieri de jihui; |
| | fest means: a. jiayan, b. shitang, c. shengyan; |
| Gest not | jie shi de nao ta jie ta men; |
| gentleman | bushi shenshi de gushi; |
| | gest means: a. chuanqi, b. gushi, c. gushi; |
| Hest order me | hen si ta ao de mi; |
| | xunling mingling wo; |
| | hest means: a. ai si ta, b. hen si ta, c. cai si ta; |
| Invest money | yin wei shi de ma li; |
| | touzi jinqian (jiushi yao ni xiang mali touzi jinqian); |
| | Invest means: a. jieqian, b. touqian, c. touziqian; |
| Jest laugh | ji si ta la fu; |
| | chaoxiao xiaohua (guafu xiang nanren xiang feng le, jide |
| | dao jieshang la fu, jianzhi shi chaoxiao he xiaohua); |
| | Jest menas: a. shangxin, b. tongku, c. chaoxiao; |
| Lest moral bad | le si ta mo ru bai de; |
| | miande ta shihuai; |
| | Lest means: a. yimian, b. yinwei, c. zongshi; |
| Mestizo | mi shi ti rou; |
| | hunxueer (xianzai shehui, dongxifang hunxue, hunxue de |
| | haizi hen piaoliang miren); |
| | Mestizo means: a. huangshi xuetong, b. pingmin |
| | xuetong, c. zazhong; |
| Nest egg | nai si ta er ge; |
| | niaochao jidan; |
| | nest means: a. shandong, b. fujin, c. chaoxue; |
| Oriental | ao ren tou, po ren ye si ta; |
| person east | dongfang de (qiongren ao chutou, dongfang de tai hao |
| | chi le, kexi gei yesi le); |
| | east means: a. xifang, b. dongfang, c. beifang; |
| Pest | pai si ta; |
| | haichong (weishenme pai ta, pai si ta haichong, yinwei |
| | Pest shi you aizibing de haichong); |
| | pest means: a. huangchong, b. haichong, c. yichong; |
| Quest person | kuai si de; |
| | shenwen ta, xunzhao ta, gei ta yanshi; |
| | quest means: a. huozhe de, b. ai si ta, c. xunwen ta; |
| Restroom die | zhuai shi de ru mu; |
| | weishengjian siwang (si le de xian zai fangjian li xiuxi, |
| | you shiniao chou de fangjian shi cesuo); |
| | restroom means: a. dating, b. weishengjian, c. yiyuan; |
| Seststar | sai shi tan sai se mi; |
| Sesamum | liuxianqin zhima; |
| | Seststar means: a. wuxianqin, b. sanxianqin, |
| | c. liuxianqin; |
| Test taxi | te shi ta tai ke sai; |
| | ceshi chuzuche; |
| | test means: a. jiayongche, b. chuzuche, c. shiyan; |
| Vest skirt | wei si de, si ke de; |
| | beixin qunzi; |
| | vest means: a. kuzi, b. beixin, c. dayi; |
| Untested taxi | ang te shi ta tai ke sai; |
| | wei jing ceshi de, chuzuche (gang ceshi guo de chuzuche |
| | yisi shi buyong zai ceshi le); |
| | untested means: a. zhengzai ce, b. ce guo de, |
| | c. buyong ce |
| West invest | wo ai si ta yin wei shi ta ma li; |
| money | xifang touzi jinqian; |
| | west means: a. dongfang, b. nanfang, c. xifang; |
| exit out door | ai ke si te, ao te er, duo er; |
| | chukou waimian men; |
| | exit means: a. chukou, b. jinmen, c. meimen; |
| Yester | ni ai ta ye si ta; |
| yesterday | xiri zuotian; |
| | Yesterday means: a. mingtian, b. houtian, c. zuotian; |
| Zest oil | re si ta ao you; |
| | tiaoweipin you (ao chu you lai gan shenme? Yong ao |
| | chulai de you qu tiao fancai de weidao); |
| | Zest means: a. dongfang, b. reyou, c. tiaoweipin; |

The main body is ook and the transformations of the main body include ood, oot, oor, oom, etc. The following example shows some words formed by the main body ook and the transformations thereof and the Chinese translations of the words represented by Pinyin.

| | Chinese translation |
|---|---|
| English word | represented by Pinyin |
| Book | shu |
| Cook | zuofan |
| Door | men |
| Food | shiwu |
| Foot | jiao |
| Good | hao |
| Hook | gouzi |
| Hood | maodou |
| Icon | ouxiang |
| Jook | zuofan |
| Knot | zuofan |
| Look | kan |
| Loom | yinyinchuxian |
| Mood | ganqing |
| Noodle | miantiao |
| Oak | xiangshu |
| Poor | keliande |
| Pool | shuichi |
| Quod | jianyu |
| Root | genjing |
| Room | fangjian |
| Roof | louding |
| Soot | yanhui |
| Tool | gongju |
| Toot | xinhao |
| Unlocked | wuying |
| Veer | zhuanxiang |
| Wood | shumu, senlin |
| Explored | baozha |
| Yoo-hoo | yaohe |
| Zoom | jingtou, jiaoju |

The main body is ight. The following example shows some words formed by the main body ight and the Chinese translations of the words represented by Pinyin.

| English word/phrase | Chinese translation represented by Pinyin |
|---|---|
| Light | deng, zhaoming |
| Night | wanshang |
| Bright | mingliang de |
| Delight | kuaile, gaoxing |
| Enlight | qifa, kaidao, chanming |
| Flight | feixing, banji |
| Highlight | juguangdeng |
| Candle light | zhuguang |
| Green light | lvdeng |
| Jack light | jiekedeng |
| Neon light | nihongdeng |
| Plight | kunjing, ku'nan, yasong, baozheng |
| Rear light | weideng |
| Red light | hongdeng |
| Top light | dingguang |
| Unlighted | bu faguang de |
| Victory light | shengli zhi guang |
| White light | baiguang |
| X-ray light | X guangxian |
| Yellow light | huangdeng |
| Zoom light | jiaojudeng |

The main body is light and the transformations of the main body include ight, ought, and aught. The following example shows some words/phrases formed by the main body light and the transformations thereof and the Chinese translations of the words/phrases.

| English word/phrase | Chinese translation represented by Pinyin |
|---|---|
| Alight | shaozhao de, dianliang zhe de |
| Bight | haiwan, shengquan, quxian |
| Bright | mingliang de, chetoudeng |
| Caught | buzhuo |
| Dight | zhuang, shi, zhengdun |
| Eight | bazixing |
| Delight | gaoxing |
| Fight | dajia, fandui |
| Fright | jingxia, jinghai |
| Frighten | jingxia, konghe |
| Freight | huoyun, yunfei, chuanhuo |
| Glitter | shanguang, canlan |
| Hight | beichenwei |
| Height | gaodi, gaodu, shengao, dingdian |
| In light of | genju |
| Jacklight | zhaomingdeng, goudeng |
| Knight | qishi, wushi, jueshi |
| Light | guang, guangliang, deng |
| Might | liliang, weili, shili |
| Night | yewan, wanshang, heian |
| Owllight | bomu, weiming |
| Outright | quanbu de, like de, shuaizhi de, |
| | yizhixiangqian, tongkuai de |
| Plight | kunjing, jingkuang, shiyue |
| Quality | zhiliang, pinzhi, texing, caineng |
| Right | zhengque, youbian, zhengyi |
| Sight | shili, jingxiang, yanjie, jianjie |
| Slight | qingwei de, shaoliang de, xichang de, |
| | buzhongyao de |
| Tight | jinde, mifeng de, bengjin de, mafan de, yanli de, |
| | meikong de |
| Unrighteous | xiee de, bugongping de, bugongzheng de, |
| | zuishen de |
| Victory light | shenglizhiguang |
| Wight | renlei, shengwu |
| Wright | laite (a surname) |
| Weight | zhongliang, zhongli, fudan |
| Write | xie, xiezi, xiezuo, xiequ, xiexin |
| Exit light | chukoudeng |
| Yellow light | huangsedeng |
| Zoom light | bianjiaoguang |

The main body is ail and the transformation is aim. The following example shows some words/phrases formed by the main body ail and the transformations thereof and the Chinese translations of the words/phrases represented by Pinyin.

| English word/phrase | Chinese translation represetend by Pinyin |
|---|---|
| Ail | shi . . . fannao |
| Bail | baoshi, xintuo |
| Claim | qingqiu |
| Claim damage | qingqiu peichang |
| Daily | meiri, meitian |
| Detail | xiangxi de |
| Email | dianyou |
| Fail | shibai |
| Gaily | kuaile de, xiqiyangyang de |
| Hail | bingbao |
| A hail of bullets | tanyu |
| In hail storm | baofengyu |
| Jail | jianyu |
| Label | biaoqian |
| Mail | youjian |
| Nail | zhijia |
| On the hail | zai bingbao zhong |
| Pail | tong |
| A pail of milk | yitong niunai |
| Sail | hangxing |
| Tail | weibo |
| Until | zhidao |
| Vale | shangu |
| Wail | kuqi |
| Explain | jieshi |
| Yam | xiyangshu |
| Zoom | jiaoju |

The main body is one. The following example shows words/phrases formed by the main body one and the Chinese translations of the words/phrases represented by Pinyin.

| English word/English phrase | Chinese translation represented by Pinyin |
|---|---|
| Bone | gutou |
| Cone | yuanzhuiti |
| Done | wanchengle |
| Everyone | meigeren |
| Fond | xihuande, wenroude |
| Gone | liqude |
| Hone | modaoshi |
| Honest | chengshide |
| Icon | tubiao, ouxiang, xiaoxiang, huaxiang |
| Jones | qiongsi(xingshi) |
| Know | zhidao |
| Knoll | xiaoshan |
| Knot | dajie |
| Knock | qiao |
| One | yige |
| Ounce | angsi, shaoliang, xuebao |
| Pone | yumibng |
| Quota | peie |
| Quinine | kuining |
| Quote | baojia |
| Road Rondo | huixuanqu |
| Rouse | huanxing |
| Ring | anning |
| Son | erzi, haizi, nanxing houyi |
| Song | gequ |
| Tone | yuqi, yindiao, yinse |
| Upon | zaishangmiande |
| Urine | niao |
| Vocal | gechangde |
| Wonder | jingqi |
| Exonerate | mianzui |
| Explode | baozha |
| Yon | nabiande |
| Zoo | dongwuyuan |
| Zoon | fayu wanquan de geti |
| Zoom | jisu shangsheng |

The main body is our. The following example shows some words/phrases formed by the main body our and the Chinese translations of the words/phrases represented by Pinyin.

| English word/phrase | Chinese translation represented by Pinyin |
|---|---|
| Arbour | liangting |
| Bourg | youchengbao de cunzhen |
| Court | fayuan |
| Dour | yanli de |
| Detour | shi . . . raodaoerxing |
| Encourage | guli |
| Engine | yinqing |
| Four | sige |
| Gourd | hulu |
| Hour | xiaoshi |
| House | zhuzhai |
| Honest | chengshi de |
| Idolize | jiduan chongbai |
| Icon | tubiao |
| Jour | zazhi |
| Journal | ribao |
| Journey | lvxing |
| Jingo | shawen zhuyizhe |
| Know | zhidao |
| Lour | zhoumeitou |
| Nourish | ziyang |
| Mourn | aodao |
| Our | women de |
| Pour | qingxie |
| Quote | yinyong |
| Quota | pei'e |
| Rouse Rondo | huixuanqu |
| Sour | suan de, fajiao de, cier de, suanchou de, taoyan de |
| Source | laiyuan, shuiyuan, yuanshi ziliao |
| Tour | lvyou |
| Urine | niao |
| Vaccine | yimiao, niudoumiao |
| Wonder | huaiyi, jingqi, dui . . . gandao jingya |
| Explode | baozha, baofa, jizeng |
| Your | ni de, nimen de |
| Zoo | dongwuyuan |

The main body is air. The following example shows some words/phrases formed by the main body air and the Chinese translations of the words/phrases represented by Pinyin.

| English word/phrase | Chinese translation represented by Pinyin |
|---|---|
| Air | kongqi |
| Bairn | xiaohai |
| Bait | yinyou |
| Cairn | shiduijinianbei |
| Cairo | (aiji shoudu)kailuo |
| Dairy | naizhipin |
| Daily | richang de, meiri de |
| Ear | erduo |
| Fair | gongping de |
| Gait | bufa |
| Gain | zengjia |
| Garlic | dasuan |
| Hair | toufa |
| Impair | sunhai |
| Impart | geiyu |
| Iarovize | shi (zhiwu) chunhua |
| Jar | guan |
| Jam | guojiang |
| Kaiser | (deguo) kaisa huangdi |
| Kaiserism | ducaitongzhi |
| Kaka | ganlanse yingwu |
| Kaki | yazhou shishu |
| Lair | jinru shouxue |
| Laird | lingzhu |
| Large | da de |
| Maid | nvpu |
| Major | zhuyao de |
| Nairobe naissance | dansheng |
| Narrow | xiazhai de |
| Nark | migao |
| Oar | jiang |
| Oasis | lvzhou |
| Oat | yanmai |
| Oak | xiangshu |
| Oath | shiyan |
| Pair | yidui |
| Parent | fumu |
| Repair | xiuli |
| Pare | xiaojian |
| Quake | zhendong |
| Quail | weisuo |
| Quit | likai |
| Sail | hangxing |
| Said | shuo |
| Wail | kuqi |
| Wind | chanrao |
| Tare | pizhong |
| Target | mubiao |
| Unfair | bu gongping de |
| Unfasten | jiekai |
| Vair | songshupi |
| Vale | gu |
| Vary | bianhua |
| Varec | haizao |
| Exalted | gaoshang de |
| Exam | kaoshi |
| Exarch | (dongluomadiguo de)zongdu |
| Examine | jiancha |
| Yak | maoniu |
| Yam | shuyu, ganshu |
| Zaire | sayi gongheguo |
| Zany | xiaochou |
| Zap | huoli, mengchong |

The main body is ake and the transformation is ak. The following example shows some words/phrases formed by the main body ake and the transformation hereof and further shows the Chinese translations of the words/phrases represented by Pinyin.

| English word/phrase | Chinese translation represented by Pinyin |
|---|---|
| Ake | miyao jiaohuan |
| Bake | hongbei |
| Cake | daogao |
| Dak | yizhan |
| Dark | heian de |
| Empathy | yiqingzuoyong |
| Embark | congshi |
| Embank | zudiweidu |
| Fake | jiahuo |
| Gallon | jialun (volume unit) |
| Gal | jialun (zhongli jiasudu danwei) |
| Hake | xueyu lei |
| Hakeem | daxuezhe |
| Hack | kan |
| Hacker | haike |
| Imbark | chuangye |
| Jake | shangdeng de |
| JAL | riben hangkong gongsi |
| Jakes | cesuo (huwai) |
| Kaki | yazhou shizishu |
| Kakemono | zihua |
| Lake | hu |
| Make | shide, jinxing, buzhi |
| Naked | luoti de |
| Oak | xiangshu |
| Pakistan | bajisitan (nanya guojia mingzi) |
| Quake | zhendong |
| Rake | shousuo |
| Sake | mudi |
| Sax | sakesiguan |
| Take | na, qu |
| Unmaking | shi . . . huaiyuan |
| Valance | weiman |
| Valentine | qingren |
| Excavate | wajue |
| Yak | maoniu |
| Zag | jizhuan, jibian, juchixing zhuanjiao |

The main body is ing. The following example shows some words/phrases formed by the main body ing and the Chinese translations of the words/phrases represented by Pinyin.

| English word/phrase | Chinese translation represented by Pinyin |
|---|---|
| Bing | dui |
| Cling | jianchi |
| Ding | xiang |
| Decline | xiajiang |
| Eking | zengjia |
| Finger | shouzhi |
| Ginger | jiang |
| Hinge | jiaolian |
| Hint | anshi |
| Ingoing | xinjin de |
| Jingle | shi . . . yayun |
| King | guowang |
| Ling. | xueyu |
| Linger | paihuai |
| Ming | mingchao |
| Mingle | hunhe |
| Ninon | bochou |
| Nine | jiu |
| Opening | kaishi |
| Ping | zidan feiguo kongzhong de shengyin |
| Pin | datouzhen |
| Quinin | kuining |
| Queen | nvwang |
| Ring | anning |
| Sing. | changge |
| String | xisheng |
| Ting | dingding sheng |
| Tinge | danse |
| United kingdom. | lianhewangguo (yingguo) |
| Wing | chibang |
| Exist | cunzai |
| Exit | chukou |
| Yin. | zhongguo de yindai |
| Yip | jiaohansheng |
| Zing | huoli |

The main body is ay. The following example shows some words formed by the main body ay and the Chinese translations of the words represented by Pinyin.

| English word | Chinese translation represented by Pinyin |
|---|---|
| Apply | shenqing |
| Bay | haiwan |
| Cay | shanhuqiao |
| Calefy | shi . . . biannuan |
| Day | yitian |
| Employ | shiyong |
| Layer | jieceng |
| Elapse | xiaoshi |
| Fay | xiaoxiannv |
| Flay | bopi |
| Flayer | dianliceng, kuaile de |
| Gay | tongxinglianzhe |
| Hay | gancao |
| Hale | qiangzhuang de |
| Imply | hanxu |
| Implant | zhongzhi |
| Jay | songji |
| Jazz | jueshiyue |
| Jab | chuo |
| Julousie | baiyechuang |
| Kayo | jidao |
| Key | jian |
| Lay | tangxia |
| May | keneng |
| Nay | jujue |
| Naked | luoti de |
| Oar | jiang |
| Oak | xiangshu |
| Pay | zhifu |
| Pale | cangbai de |
| Quay | matou |
| Quake | zhendong |
| Ray | shexian |
| Rale | luoyin |
| Say | jiang |
| Tay | taihe |
| Unsay | chehui |
| Unsaid | weishuochukou de |
| Vase | huaping |
| Day | yitian |
| Vale | xigu |
| Yacht | chengyou |
| Exact | zhunque de |
| Expand | kuozhang |
| Zany | xiaochou |
| Zag | jizuan |

The main body is ar and the transformations are ard, ark, and art. The following example shows some words/phrases formed by the main body ar and by the transformations thereof, and further shows the Chinese translations of the words/phrases represented by Pinyin.

| English word/phrase | Chinese translation represented by Pinyin |
|---|---|
| Art | yishu, meishu, yishupin |
| Bar | jiuba |
| Barbecue | kaorou |
| Car | qiche |
| Card | kapian |
| Dark | heian de |
| Embar | huijin |
| Far | yaoyuan de |
| Forward | xiangqiang de |
| Gar | zhidao jizai daodan |
| Garden | huayuan |
| Hard | nuli de |
| Harm | shanghai |
| Harsh | yanli de |
| Impar | bu chengdui de |
| Impark | weizuogongyuan |
| Impart | chuanshou |
| Jar | guan |
| Karaoke | kala OK |
| Lar | yeti ranliao hangkong huojian |
| Large | da de |
| Mar | sunhui |
| March | xingjun |
| Match | bisai |
| Nark | mitan |
| Nation | guojia |
| Oar | jiang |
| Open market | gongkaishichang, ziyoushichang |
| Open heart | kaifang de xin |
| Par | biaozhun |
| Parade | youxing |
| Rare | xiyou de |
| Share | fenxiang |
| Sarajevo | salarewo |
| Sarcasm | fengci |
| Tar | jiaoyou |
| Target | mubiao |
| Unbar | dakai |
| Vary | bianhua |
| Variety | duoyang |
| War | zhanzheng |
| Yard | yuanzi |
| Yarage | caozonglinghuoxing |
| Exarch | zongdu |
| Excavate | fajue |
| Zag | jizuan |

The main body is eat. The following example show some words formed by the main body eat, the Chinese translations of the words represented by Pinyin, and English sentences including the corresponding words/phrases.

| | Chinese translation represented by Pinyin (English |
|---|---|
| English word | sentence including the corresponding English word/phrase) |
| Abet | tiaosuo, zuzhang |
| | (English sentence: He was abetted in murder by his |
| | friends.) |
| Beat | jida, da |
| Cease | tingzhi |
| Death | siwang |
| Eat | chi |
| Feat | zhuangju |
| Great | da, weida, zhuangda |
| Heat | re, reli, shuqi |
| Ideate | yunninag |
| | (English sentence: Many students ideate their own views |
| | in their colleges) |
| Jean | niuzaiku |
| | (English sentence: This girl likes to wear Jean.) |
| Knead | rou, anrou |
| | (English sentence: I want the masseur to knead my back.) |
| Lead | lingdao, yinling |
| Meat | rou, roulei |
| Neat | qingjie de, zhengqi de |
| | (English sentence: I need a neat room.) |
| Oecology | shengtaixue, shehuishengtaixue |
| Oenology | niangjiu |
| Peat | nitan |
| Quest | tansuo |
| Seat | zuowei |
| | (English sentence: Are there any good seats?) |
| Teat | rutou |
| Unseat | laxiama |
| | (English sentence: Lack of education will unseat you for |
| | better job.) |
| Veal | xiaoniurou |
| Weather | tianqi |
| Exeat | duanqi waichu xuke |
| Zeal | reqing |

The main body is can and the transformations are eap and ealeat. The following example shows some words formed by the main body can and the transformations thereof, and further shows the Chinese translations of the words represented by Pinyin.

| English word | Chinese translation represented by Pinyin |
|---|---|
| Abeam | zhenghengzhe |
| Bean | dou, zuifeng, haowujiazhi de dongxi |
| Beam | hengliang, guangxian, dianbo, chuankuan, ganchen |
| Clean | qingjie de, ganjing de, qingbai de |
| Dean | yuanzhang, xizhuren, jiaowuzhang, zhuchi mushi |
| Eanling | yanggao, xiaoyang |
| Feat | gongji, zhuangju, jiyibiaoyan |
| Fear | haipa, kongju, jingwei, danxin |
| Gean | ouzhou tianyingtao |
| Glean | shouji (ziliao), shi (luosui) |
| Gleam | weiguang, shanguang, shunxi de yixian |
| Heap | dui, xuduo, leiji |
| Heal | zhiyu, quanyu, hejie |
| Head | tou, touting, shangduan, zuiqian de bufen, lijieli |
| Icy | bingleng de, lengdan de, jiebing de |
| Jean | niuzaiku |
| Lean | shou de, pinfa de, qianshou de |
| Mean | pingjun de, beibi de, dilie de |
| Neat | lingqiao de, zhengjie de, youya de, qizheng de, pinghua de |
| Ocean | haiyang, daliang, guangkuo |
| Open | gongkai, kongkuang, huwai |
| Reap | shouhuo, huode, shouge |
| Sean | xiaoen (nanzi mingzi) |
| Sea | hai, haiyang, xuduo, daliang |
| Team | tuandui |
| Tea | chaye, chashu, Chadian |
| Queasy | outu de, buwending de, cuitu de |
| Quality | zhiliang, pinzhi |
| Unclean | buchunjie de, xingweibujian de |
| Veal | xiaoniu, xiaoniurou |
| Wean | shi . . . duannai, shi . . . duannian, shi . . . fangqi |
| Exes | feiyong |
| Yean | chanxiaoyang |
| Zeal | reqing, rexin, recheng |

The main body is oy and the transformations are ay and ly. The following example shows some words formed by the main body oy and the Chinese translations of the words represented by Pinyin.

| English word | Chinese translation represented by Pinyin |
|---|---|
| Boy | nanhai, nanren |
| Coy | miantian de, niunizuotai de, paxiu de |
| Doyle | kenandaoer (yingguo yishi, xiaoshuojia, |
| | tuilixiaoshuojia), daoer (renming) |
| Enjoy | xinshang, xiangshou, xiai, shi . . . guode kuaihuo |
| Fly | feixing, cangying, liangyikunchong |
| Goy | yijiaotu, yibangren, feiyoutairen |
| Glory | guangrong, rongyu, zansong |
| Hoy | da pingdichuan, yinren zhuyi huozhe zhuigan shengchu |
| | de hujiaosheng |
| Icky | [lingren taoyan de, feichang taoyan de |
| Icon | tubiao, ouxiang, xiaoxiang, huaxiang, shengxiang |
| Joy | qiaoyi (nvzi mingzi) |
| Key | (dayinji deng de)jian, guanjian, yaoshi |
| Loy | luwa (nanzi mingzi) |
| Moony | yueliang side, huanghu de, fadai de |
| Nog | muding, zhijia |
| Opera | geju, gejuyuan, gejutuan |
| Ply | houdu, banceng, zhe |
| Play | youxi, bisai, juben |
| Quay | matou |
| Roy | luoyi (nanzi mingzi) |
| Soy | dadou, jiangyou |
| Toy | wanju, xiao zhuangshipin, buzhiqian de dongxi |
| Up | shangsheng, fanrong |
| Vow | fashi, shiyan, xuyan |
| Xo. | bailandijiu |
| Employ | guyong |
| Zoya | zuoya (renming) |

The main body is et and the transformations are ent and it. The following example shows some words/phrases formed by the main body et and the transformations thereof, and further shows the Chinese translations of the words/phrases represented by Pinyin.

| English word/phrase | Chinese translation represented Pinyin |
|---|---|
| Abet | shandong, jiaosuo, zhichi |
| Bet | dadu, duzhu, beidadu de shiwu |
| CET | daxue yingyu kaoshi |
| Deter | zhizhi, zuzhi, shi . . . daxiao niantou |
| Detent | zhidong zhuangzhi, jizhua |
| Detente | huanhe |
| Detention | juliu, yanchi, wanliu |
| Feet | jiao, yunjiao |
| Get | shengzhi, youshou |
| Het(Heavy Equipment | zhongxing shebei yunshuche |
| Transporter | |
| Item | tiaokuan, xiangmu, yize |
| Jet | penshe, penzui, penqishi feiji |
| Kent | kente (yingguo dongnanbu zhouming) |
| Ketchup | fanqiejiang |
| Let | zhangai, chuzuwu |
| MIT | masheng ligong xueyuan |
| Mite | jixiaoliang |
| Net | wang, wangluo, jingli, shijia |
| Opt | xuanze |
| Quit | likai, tuichu |
| Ret | shouchao fulan, qinshui shi rouruan |
| Set | jihe, yitao, bujing, zhuangzhi, shuli, dianran, |
| | dianzhui |
| Tent | zhangpeng, zhuchu, weimu |
| Unset | wei zhuangpei de, wei jian'gu de |
| Vet | shencha, zhenliao |
| Wet | yutian, shiqi |
| Exeat | duanshi lixiao xuke |
| Exert | yunyong, fahui, shiyi yingxiang |
| Exec | zhixing, zhixing chengxu, zhuren canmou, |
| | fujianzhang |
| Yet | danshi, ran'er |
| Zeta | xilayu diliuge zimu |

The main body is at. Some words formed by the main body at and the Chinese translations of the words represented by Pinyin are shown as follows.

| English word | Chinese translation represented Pinyin |
|---|---|
| Bat | bianfu, qiubang, kuozhanming |
| Dat | shuzi luyindai, DOS wenjianming, shuju wenjian |
| Eat | chi, he, fushi, fanrao |
| Fat | feide, pande, younide, fengmande |
| Gat | shouqiang |
| Hat | maozi |
| Kant | kangde (deguo zhexuejia) |
| Lat | (latuoweiya) huobi danwei |
| Mat | dian, dianzi, chenbian |
| Nat | nate (nanzi xingming), sugelan, weiershi de |
| | minzu zhuyizhe |
| Opt | xuanze |
| Quad | sifang yuanzi, sibaotai zhiyi, qiantiao, chengtao |
| | de sijian dongxi |
| Rat | laoshu, pantu |
| Sat | zuo |
| Unseat | bamian, boduo xiwei, shi . . . shiqu zige |
| Vat | datong, zhijitong |
| Exact | zhunquede, jingmide, jingquede |
| Yates | shoumenren |
| Zara | zhala (nansilafu chengshi mingzi, xibanya pinpai) |

The main body is id and the transformations are nd and iddle. Some words/phrases formed by the main body id and the transformation thereof, and the Chinese translations of the words/phrases represented by Pinyin are shown as follows.

| English word/phrase | Chinese translation represented by Pinyin |
|---|---|
| Aid | yuanzhu, bangzhu, zhushou, bangzhuzhe |
| Bid | chujia, jiaopai, nuli zhengqu |
| CID (Commission for | guoji kaifa weiyuanhui |
| International Development) | |
| Did | zuo |
| End | jieshu, mubiao, jintou, moduan, siwang |
| Fid | (yingmuding, weishuan, zhichengcai, daxing |
| | muding, houpian shiwu |
| Fiddle | xiaotiqin, huche |
| Girdle | yaodai, weiraowu, funv jinshenda |
| God | shen, shangdi |
| Hid | yincang, zhebi |
| Hide | duocang, shoupi, duocangchu |
| Huddle | quansuo |
| I'd (I would) | wo yuanyi |
| Jidda | jida (shatealabo xibu gangshi) |
| Jird | shashu |
| Kid | xiaohai, xiaoshanyang |
| Kiddy | xiaohai, xiaojiahuo, xiaoshanyang |
| Lid | gaizi, yanjian, xianzhi |
| Mid | zhongjian de, zhongyang de |
| Middle | zhongjian, zhongyang, yaobu |
| Needle | zhen, zhizhen, ciji, zhenzhuangwu |
| Ovid | aoweide (guluoma shiren) |
| Pid (Proportion Integration | bili jifen weifen |
| Differentiation) | |
| Piddle | saniao, guihun, tiaoshi, zuo wuliao shi |
| Quid | jujuewu, yiyingban, yibang jinbi |
| Rid | shi . . . baituo, shi . . . qudiao |
| Riddle | miyu, cushai, mi yiban de |
| | ren/dongxi/shiqing |
| Sid (sudden ionospheric | dianliceng turan saodong |
| disturbance) | |
| Sidle | cezou, aijin |
| Side | fangmian, cemian, pangbian |
| Uuid (Universally Unique | tongyong weiyi biaozhifu |
| Identifier) | |
| Unhid | weishou yaoqing |
| Vid | jian, cancan |
| Vied | jingzheng |
| Vids | jian |
| Vidal | weidaier (putaojiuming), bidaer (nanzi |
| | mingzi) |
| Wkd (World Kidney Day) | shijie shenzang ri |
| Wide | guangfan de, kuan de, guangkuo de, |
| | zhangda de, yuanli mubiao de |
| Waddle | panshan, yaobai de buzi |
| Xidd | fei |
| Expired | guoqi de, shixiao de |
| Expand | kuozhang, shi . . . pengzhang, xiangshu |
| Expend | huafei, xiaohao, yongguang, haojin |
| Yi | yiren, yiyu |
| Zit | qingchundou, mianpao |
| Zip | lalian, huoli, jingli, jianxiaosheng, |
| | siliesheng |

The main body is est. Some words formed by the main body est and the Chinese translations of the words represented by Pinyin are shown as follows.

| English word | Chinese translation represented by Pinyin |
|---|---|
| Arrest | daibu |
| Best | zuihaode |
| Crest | jiguan |
| Destine | mingyun |
| East | dongfangde |
| Fest | jieri |
| Gest | gushi |
| Hest | xunling, mingling |
| Invest | touzi |
| Jest | xiaohua, wanxiao |
| Lest | weikong, yimian |
| Mestizo | hunxue-er |
| Nest | niaochao |
| Pest | kunchong |
| Quest | shenwen, xunzhao, yanshi |
| Rest | xiuxi |
| Sesamum | zhima |
| Test | chucuche |
| Vest | beixin |
| West | xifang |
| Yesterday | zuotian |
| Zest | tiaowei |

The main body is old. Some words/phrases formed by the main body old and the Chinese translation of the words/phrases represented by Pinyin are shown as follows.

| English word/phrase | Chinese translation represented by Pinyin |
|---|---|
| Abound | fuyu, chongman |
| Bold | dadan de, yingyong de, heiti de, houyanwuchi de, |
| | xianjun de |
| bolt | huluntunxia, shangmenshuan |
| Cold | hanleng de, lengdan de, bu reqing de, |
| | shiquzhijue de |
| Doldrums | youyu, chidaowufengdai |
| Enfold | yongbao, baoguo, zhedie, weirao |
| Fold | zhehen, xintu, yanglan |
| Gold | jin, huangjin, jinse, jinbi |
| Hold | kongzhi, baoliu |
| Inflod | baoguo, zhedie |
| Joy | qiaoyi (nvren mingzi) |
| Knot | jie, jieliu, geda, haili/xiaoshi |
| Loll | lanyangyang de yikao |
| Mold | suzao, shi . . . famei, yong muzi zhizuo |
| Nod | diantou, dadun, baidong |
| Old | chenjiu de, gulao de, nianlao de |
| On hold | zanting, shangwei banli de shiqing, denghoujieting |
| Polder | kaotuodi |
| Pole | gan, jidian, dianji |
| Quod | jianyu, laoyu |
| Roll | juan, juanxingwu, mingdan, yaohuang |
| Rolled | zhazhi de, gunzhi de |
| Gold | jin, huangjin, jinse, jinbi |
| Sold | mai, xiaoshou |
| Told | gaosu, jiangshu |
| Unfold | dakai, chengxian |
| Voice | shengyin, sangyin, fayanquan, yuanwang |
| Vault | gongding, chenggantiao, dixiashi |
| Wold | huangyuan, wu shumu de shandi |
| World | shijie, lingyu, yuzhou, shisu, quanrenlei |
| Explode | baozha, tuifan |
| Yolk | danhuang, luanhuang, yangmaozhi |
| You | ni, nimen |
| Yond | bichu de, nabian de |
| Zola | zuola (faguo zuojia ji xiaoshuojia) |

The main body is ire and the transformations are ere and ear. Words formed by the main body ire and transformations thereof, and the Chinese translations of the words represented by Pinyin are shown as follows.

| English word | Chinese translation represented by Pinyin |
|---|---|
| Able | nenggou, younengli de, nenggan de |
| Born | tiansheng de |
| Corn | yumi, guwu, jiyan |
| Dire | kepa de, beican de, jiduan de |
| Empire | diguo, diwang tongzhi, junquan |
| Fire | huo, huozhai, paohuo, luhuo, reqing, jiqing |
| Girl | nvhai, guniang, never, nvpengyou |
| Hire | guyong, zuyong, zujin, gongqian |
| Here | zheer |
| Ire | fennu |
| Kite | fengzheng |
| Lire | lila (yidali huobi danwei), yuedu(fayu) |
| Mere | jinjin de, zhibuguo de |
| Nirvana | niepan |
| Opine | yiwei, xiang, biaoshiyijian |
| Pore | qikong, xiaokong |
| Quire | yidao, yidie duizhe de shougao |
| Sire | dianxia, daren, nanxingzuxian, xiongxingqinchu |
| Tire | luntai, toushi |
| Unhindered | bushouzudang de, meiyouzhangai de |
| Vires | huoli |
| Virus | bingdu |
| Wire | dianxian, jinshusi, dianbao |
| Where | nali |
| Explore | tansuo, tance, tanxian |
| Tier | ceng, pai, hang, lie, dengji |
| YIR | nichen |

The main body is ice and the transformations are ace and ase. Some words formed by the main body ice and the transformations thereof, and the Chinese translations of the words represented by Pinyin are listed as follows.

| English word | Chinese translation represented by Pinyin |
|---|---|
| Abase | shi . . . qianbei, jiangdi . . . diwei, jiangdi . . . pinge |
| Bice | lvse, huilanse, huilanse yanliao |
| Case | baowei, rongqi |
| Dice | shaizi |
| Entries | jinru, cimu |
| Face | lian, biaomian, mianzi, mianrong, waiguan, weixin |
| Grace | youya, enhui, meili, cibei |
| Hive | fengfang, fengchao, renao de changsuo |
| Ice | bing, bingqilin, jinchi, zuanshi |
| Juice | zhi, ye, guozhi |
| Kiss | wen, qingfo |
| Lice | shizi |
| Mice | laoshu |
| Nice | jingmi de, meihao de, xiwei de, heai de |
| Oasis | lvzhou, shushi de defang, lingren kuanwei de shiwu |
| Quite | hen, xiangdang, wanquan |
| Rice | daomi, dami |
| Race | shu, zhong, zhongzu, renzhong, jiating, mendi |
| Since | yinwei, youyu, jiran, zicong |
| Save | qiujiu, jiuyuan |
| Trace | henji, zongji, weiliang, jiangsheng |
| Vice | fu de, daiti de |
| Voice | shengyin |
| Exile | liufang, chongjun, fangzhu, bei fangzhuzhe, liufan |
| Yam | shuyu, ganshu |
| Zyme | mei, bingjun |

The main body is ash and the transformation is ush. Some words formed by the main body ash and the transformation thereof, and the Chinese translations of the words represented by Pinyin are shown as follows.

| English word | Chinese translation represented by Pinyin |
|---|---|
| Ash | hui, huijin |
| Bash | menglie de yiji, tongji |
| bush | guanmu, aishucong |
| Cash | xiankuan, xianjin |
| Dash | pozhehao, chongzhuang |
| dish | die, pan, yidaocai |
| Encash | duixian, fuxian |
| Fash | fannao, mafan |
| fashion | shishang, shizhuang, yangshi, shimao renwu |
| Fish | yu, yulei |
| Gash | henshen de liefeng, kande henshen de shangkou |
| Gush | yongchu, pengfa |
| Hash | duosui de shiwu, hunza, pincou, chongxin biaoshu |
| Hush | anjing, sujing, jianmo |
| Jasy | nichen |
| Kasha | qiaomaizhou, maizhou, maihu |
| kush | kushen (dianying mingzi) |
| Lash | biaoda, jiemao, bianzi, zema, fengci |
| Lush | jiu, jiugui |
| Mash | siliao, huzhuangwu, maiyajiang |
| Mush | ganshang de hua, nongzhou, ruankuai, danqie |
| Nash | nashi (xingshi) |
| Oasis | lvzhou, shushi de defang, ling ren kuanwei de shiwu |
| Pash | reqing, jilie |
| Push | tui, juexin, fenli, gongji, ganjin, jinquxin |
| Quash | chexiao, zhenya, xuanbu wuxiao, daosui |
| Rash | qingshuai de, lumang de, buguhouguo de |
| Rush | chongjin, congcu, jiliu, dengxincao |
| Tash | xiaohuzi |
| Tosh | hushuo, menghua, feihua |
| Tush | quanchi, changya, liaoya |
| Ush | zuo zhaodaiyuan |
| Wash | xidi, xi de yifu, huazhuangshui, chongjiwu |
| Awash | bei lang chongda de, yu shuimian pingqi de |
| Explain | shuoming, jieshi |

The main body is ine. Some words formed by the main body ine and the Chinese translations of the words represented by Pinyin are shown as follows.

| English word | Chinese translation represented by Pinyin |
|---|---|
| Bine | mansheng zhiwu |
| Cine | dianying |
| Cinema | dianyingyuan |
| Dine | jincan |
| Engine | yinqing |
| Fine | haode |
| Gine | jieneng |
| Kine | huangniu |
| Line | zhixian |
| Mine | kuang |
| Nine | jiuge |
| Pine | kewang |
| Rine | haiyang |
| Sine | zhengxian |
| Tine | jiantou, chi |
| Vine | teng |
| Wine | putaojiu |
| Xine | xinghuamei |
| Zine | aihaozhe zazhi (refers to a magazine which is |
| | published by or for fans of sentific fantasy fiction) |

The main body is ale. Some words/phrases formed by the main body ale and the Chinese translations of the words/phrases represented by Pinyin are shown as follows.

| English word/phrase | Chinese translation represented by Pinyin |
|---|---|
| Bale | kun, dabao, baozhuang |
| Dale | shangu |
| Fale | fale (nanzi mingzi) |
| Fall | qiutian, shuailuo |
| Gale | dafeng |
| Hale | jingshenjueshuo de, laodangyizhuang de |
| Impale | cichuan |
| Kale | yuyiganlan |
| LALE | jiguang yuanziceng waiyan |
| Male | nanxing de |
| Oale | ouer (nanzi mingzi) |
| Pale | cangbai de |
| Rale | luoyin |
| Sale | xiaoshou |
| Tale | gushi |
| Vale | xigu |
| Wale | tiaohen, xuanze |
| Yale | yelu |

The main body is are. Some words/phrases formed by the main body are and the Chinese translations of the words/phrases represented by Pinyin are shown as follows.

| English word/phrase | Chinese translation represented by Pinyin |
|---|---|
| Are | changyongci |
| Bare | kong de |
| Care | guanhuai |
| Dare | tiaozhan |
| Eared | yourui de |
| Fare | jingying |
| Gare | matou |
| Hare | yetu |
| Jare(Japanese Antarctic | riben nanji kexue kaochadui |
| Research Expedition) | |
| Kare | gali |
| Lare | laer (nanzi mingzi) |
| Mare | muma |
| Nares | bikong |
| Oare | aoer (yingguo diqu mingzi) |
| Pare | xiaojian |
| Rare | hanjian de, teshu de |
| Sare(self-addressed | yixiehao dizhi de fanhui xinfeng |
| return envelope) | |
| Tare | pizhong |
| Ware | shangpin, zhipin |
| Yare | minjie de, lingmin de |
| Zare | zhaer (nanzi mingzi) |

The main body is io and the transformation is ion. Some words/phrases formed by the main body io and the transformation thereof, and the Chinese translations of the words/phrases represented by Pinyin are shown as follows.

| English word/phrase | Chinese translation represented by Pinyin |
|---|---|
| Aioli | suani danhuangjiang |
| Bio | shengwu |
| CIO (Congress of | meiguo chanye gonghui lianhehui |
| Industrial Organizations) | |
| Cion | nenya, houyi |
| Diode | erjiguan |
| Fiorin | xiaokangcao |
| Giocoso | youxi side, kaiwanxiao side |
| Hip | tunbu |
| Iodin | dianjiu |
| Kiosk | liangting |
| Jujitsu | roushu |
| Lion | shizi |
| Miosis | tongkongsuoxiao |
| Nip | jia, qiaqu |
| Oil | you |
| Pioneer | tuohuangzhe, kaifazhe |
| Pion | jiezi |
| Quip | qiaopihua |
| Rip | liekou, silie |
| Trio | sanchongchang |
| Union | tongmeng, lianhe |
| VIP | guibin, darenwu |
| Violet | ziluolan |
| viola | zhongtiqin |
| violin | xiaotiqin |
| Violate | weifan, fangai |
| Wipe | chashi |
| Exit | chukou |
| Yip | quanfei, jiaohansheng |
| Zion | youtairen |

The main body is oil. Some words formed by the main body and the Chinese translations of the words represented by Pinyin are shown as follows.

| English word | Chinese translation represented by Pinyin |
|---|---|
| Boil | zhufei, feiteng |
| Coil | panrao, xianquan |
| Doily | xiaoxing zhuangshi zhuojing |
| Embroil | shi . . . hunluan, juanru |
| Foil | bo, jinshubaopian |
| Going | chuxing, liqu |
| Hoist | shengqi, tiqi |
| Imply | anshi |
| Join | jiaru |
| Loin | yaobu |
| Moil | xukugongzuo, zuokugong |
| Noise | zaosheng |
| Oil | you |
| Soil | nitu |
| Toil | bashe |
| Unsoiled | weinongzang de, weibeipohuai de |
| Voile | baosha, sha |
| Wobble | huangdong, yaodong |
| Xylophone | muqin |
| Zoic | dongwu de, youshengwu de |

The main body is ap. Some words formed by the main body ap, the Chinese translations of the words represented by Pinyin, and English phrases or sentences including the corresponding words are shown as follows.

| | Chinese translation represented by Pinyin |
|---|---|
| English word | (English phrase or sentence including the English word) |
| Baptism | xili |
| | (English phrase: baptism of fire Cap) |
| Cap | maozi |
| | (English phrases: take off one's cap; a cap of bottle) |
| Dap | feilve, tanchushuimian |
| | (English sentence: the bird can dap along the surface of |
| | water.) |
| Encamp | zhaying |
| Flap | paida |
| | (English sentence: the birds flap them wings.) |
| Gap | liefeng |
| | (English sentence: there is a small gap in the mirror; |
| | there is a big gap between the youth and old generation.) |
| Hap | ouran, jihui, yunqi |
| Jape | kaiwanxiao, xiaohua |
| Kaput | guoshi de, guzhang de |
| Rap | shuochangyinyue |
| Sap | jingli, shi . . . shuaijie |
| Snap | paizhao, padayisheng |
| Tap | kaifa, famen |
| Uncap | dakai gaizi, tuoxia maozi |
| Vamp | xiemian, pincou |
| Warp | wanqu, niuqu |
| Exam | ceshi |
| Yap | jianjiao, kuangfei, taoyan de ren |
| zap | gongji, shasi |

In the embodiment of the present disclosure, the classification rules of the words can further include forming words according to the arrangement of the 26 letters of the English alphabet. The following words are listed as an example.

| English word | Chinese translation represented by Pinyin |
|---|---|
| Award | jiangpin, panjue |
| Become | chengwei, biande, biancheng |
| Come | zuo, jiazhuang, jiangman . . . sui |
| Camel | tuose de, anzhongse de |
| Camera | zhaoxiangji, sheyingji |
| Detail | xijie, xiangqing |
| Detain | juliu, liuzhu, dan'ge |
| Detainee | wei panjue qiufan, bei kouya zhe |
| Detainer | feifa liuzhi, wanliuzhe |
| Enact | banbu, zhiding falv, banyan |
| Enacting | banbu, zhiding falv, banyan |
| Enacts | banbu, zhiding falv, banyan |
| Fin | qi, yuchi, qizhuangwu |
| Fine | hao de, youliang de, xixiao de, jingmei de, |
| | jiankang de, qinglang de |
| Fining | chengqing, chengqingji |
| Finer | fushi, huali de fushi, xianyan fuzhuang, zhuangshi |
| Gat | shouqiang |
| Gate | damen, churukou, mendao |
| Gating | zha, xuantong |
| Gather | juji, yizhe, shouhuoliang |
| Heat | jiare, reliang |
| Hear | tingjian |
| Heart | xinzang |
| Idea | zhuyi, xiangfa |
| Ideal | lixiang de, wanmei de |
| Ideate | xingcheng gainian, xiangxiang |
| Jell | chengjiaozhuang |
| Jello | ningjiaowu |
| Jelly | guodong |
| Knot | jie, kunzha |
| Know | zhidao |
| Knew | zhidao de |
| Live | shengcun, huozhe de, xianchangzhibo de |
| Love | ai, aiqing |
| Lover | airen |
| Life | rensheng, shenghuo |
| Mar | sanyuefen |
| Mark | biaoji |
| Market | shichang |
| Neck | bozi, yiling |
| Nick | kehen, quekou |
| Nock | fan de qianbu shangduan |
| Poll | minyi diaocha, toupiao xuanju |
| Pill | yaowan, danwan |
| Pull | la |
| Quad | sibei, sibaotai zhiyi |
| Quell | yazhi, zhenya |
| Quod | jianyu |
| Quote | yinshu, yinyong, baojia |
| Quota | dingliang, ding'e |
| Quill | (ciwei huozhe haozhu) ci |
| Rood | shizijia |
| Room | fangjian |
| Roof | wuding |
| Sea | dahai, haiyang |
| Sear | shaojiao |
| Search | jiansuo |
| Tea | cha |
| Team | tuandui |
| Tear | yanlei, silie |
| Teat | naitou, rutou |
| Use | shiyong |
| USA | meilijian hezhongguo |
| Usage | shiyong |
| Wean | shi . . . duannai, shi . . . duannian, shi . . . fangqi |
| Weak | cuiruo de |
| Weal | fuli, xingfu |
| Expel | quzhu, kaichu |
| Explore | tansuo, tance, tanxian |
| Explode | shi . . . baozha, baozha, tuifan |
| Yea | zancheng, kending, tou zanchengpiao zhe |
| Yes | shide |
| Year | nian, niandu, linian |
| Zoom | jisu shangsheng, wengwengsheng, bianjiao sheying |
| Zoo | dongwuyuan |
| Zip | lalian, huoli, jingli, jiaoxiaosheng, siliesheng, |
| | yizhong chengxu yasuo de dang'an |

In another embodiment, words can be formed by the method called “five vowels identical consonants”: the five vowels can be respectively combined with two identical consonants to form five word roots, and the five word roots can be combined with the 26 letters of the English alphabet to form dozens of, even hundreds of words.

For example, the word roots can be all, al, oll, and ull. Words formed by the word roots are shown as follows with the Chinese translation of each word represented by Pinyin being in the parenthesis located thereafter.

Ball (qiu), Bell (zhong), Bill (zhangdan), Boll (ling), Bull (gongniu)

Call (hujiao), Cell (xibao, shouji), Chill (hanyi), Colla (kela), Cull (busha)

Dally (wannong), Dell (daier), Dill (yanghuixiang), Doll (wawa), Dull (pingdan)

Fall (diaoluo), Fell (shuaidao), Fill (chongman), Folly (chunshi), Full (chongmande)

Gall (naonu), Geller (gaile), Gill (sai), Grill (kaojia), Gull (ou)

Hall (dating), He'll (ta jiangyao), Hill (shanpo), Holly (shensheng de), Hull (chuanke)

Jell (guodong), Jill (ji'er), Jolly (kuaihuo de, xinggaocailie de)

Lall (laer), Lill (li'er), Loll (lanyangyang), Lull (mabi)

Mall (gouwu zhongxin), Mellow (chunhou), Mill (mo), Moll (moer), Mull (zixi sikao)

Pall (fugai), Pellet (danzi), Pill (yaowan), Poll (toupiao), Pull (tuo)

Quell (dangping, tanya), Quill (emaobi, cichuan)

Rally (tuanjie), Rill (xiaoxi), Roll (gundong)

Sally (qiaopihua), Sell (shoumai), Sill (chuangtai), Soller (lesuo), Sullage (yuni)

Tall (gaoda de), Tell (gaosu), Till (zhidao), Toll (tongxingshui), Tulle (baosha)

Wall (qiang), wallet (qianbao), Well (hao de, bucuo), will (yiyuan)

For another example, the word roots can be at, et, it, ot, and ut. Words formed by the word roots are shown as follows with the Chinese translation of each word represented by Pinyin being in the parenthesis located thereafter.

Bat (paizi), Bet (dadu), Bit (paida), Botany (zhiwuxue), But (danshi)

Cat (mao), Cet (daxue yingyu dengji kaoshi), City (chengshi), Cot (ying'er chuang), Cut (kan, qie)

Data (shuju), Debt (zhaiwu), Ditch (gou), Dot (dian), Dutch (hanlanren)

Eat (chi), Etc (deng), Either (huozhe), Eon (yuzhou), Utopia (wutuobang)

Fat (feiban de), Fete (yanqing), Fit (heshi de), Fog (wu), Future (weilai)

Gate (men), Get (dedao), Git (hunzhang), Got (dedao), Gut (danliang)

Hat (maozi), Het (xingfei de), Hit (da, ji), Hot (re), Hut (pengwu)

Jat (jiateren), Jet (penshifeiji), Jitter (doudong), Jot (ji), Jut (tuchu bufen)

Kat (alabocha), Ketchup (xihongshi jiang), Kit (shijihe), Kotow (ketou), Kuwait (keweite)

Lat (weidu), Let (rang), Lit (dianran), Lot (henduo, yunqi), Lute (pipa)

Mat (dianzi), Met (huijian), MIT (masheng ligong xueyuan), Mot (jingju), Mutable (kebian de)

Nature (ziran), Net (wangluo), Nit (meiyongde ren, hutuchong), Not (bu), Nut (j ianguo)

Oat (yanmai), Oil (you, qiyou), Ootid (luanxibao), Out (chu)

Pat (paida), Pet (chongwu), Pit (keng), Pot (guo), Put (fang)

Qatar (kadaer), Quiet (anjing de), Quilt (beizi), Quote (yinyong)

Rat (laoshu), Ret (zi), Rite (yishi), Rote (sijiyingbei), Rut (faqing)

Sat (zuo), Set (ji, yitao), Sit (zuo), Sot (zui), Supra (fojing, fabao)

Tat (suozhi), Tet (simianti), Tit (shanque), Tot (xiaohaizi), Tutor (daoshi)

Unfathered (weizhangmao de), Unfetter (jiefang), Unfit (buheshi de), Unnoted (buzudao de), Unutilized (weishiyong de)

Vat (datong, gang), Vet (shouyi), Vita (geren jianli), Vote (xuanju, toupiao)

Water (shui), Wet (shi), Wit (fengqu, zhili), Wotcha (nihao)

In another embodiment of the present disclosure, matching the whole English sentence or the whole English paragraph with the Chinese song includes: connecting the whole sentence or whole paragraph of lyrics of the song by Chinese characters to form a story.

Example about Future Tense:

Everybody should remember, grammar easily remember;

(pronucation represented by Pinyin: aiweiruibaodai shude ruimanbo, guaima guaima yirili ruimanpo)

Future tense (Will) before verbal;

(pronucation represented by Pinyin: fuyouque tengsi weiou bifoer wobo)

To be going to, you never forget it;

(pronucation represented by Pinyin: tu bi gouying tu, you naiwo fogei de)

One two three four, I will go home.

(pronucation represented by Pinyin: wan tu sirui fo, ai weiou gou houmu)

The most important thing is to remember the three names in the story, the first name is “aiweirui” which is a person's name, the second name is “tengsi” which is the name of the animal “fuyouque”; the third name is “gouyingtu” which is the nickname of “tubi”. After the names are remembered, the story can be told as follows (represented by Pinyin):

you yi ge ren jiao ai wei rui, ta dao du chang qu bao zhuo qian dai, shu de hui ye man di du bo, ye li meng jian yi pi pi guai ma guai ma, zai yi ri li shui man po, bing kan jian fu you que (wai hao jiao teng si) zai wei hai ou bi fo er, ta huan de yi di wo zhuo bo zi, huan xiao de lian shang you nai wo, zhe shi shang tian fo ye gei ta de. ta wan zhuo tu zi, yong jin si shou pa xiang rui di jing zhuo fo ye, xi ai di wei zhuo hai ou, gou nong zhuo hou zi, yong de shi yi gen mu gun.

The English song can be classified in three ways. The first one is called story remembering method describing Chinese sense, which is equivalent to the rough sketch of the painting. The second one is called Ancent Chinese concentration, which is equivalent to the monochrome of the Chinese painting. The third one is called adding the western pronunciation, which is equivalent to painting the Chinese monochrome with a strong color to change the Chinese monochrome to a pure western painting.

Therefore, the pronunciation of the English song can be easily matered.

The song can be sung in Chinese as follows (represented by Pinyin together with English words in all uppercase letters):

mei ge ren na yi ding lao ji, yu fa yu fa to bie rong yi ji;

jiang lai shi WILL (wei ou) fang zai dong ci qian, TO BE GOING TO (tu bi gou ying tu) “jiang qu” bie wang ji;

yi er san si, I WILL GO HOME (ai wei ou gou hou mu), wo jiang hui jia qu.

Furthermore, the same melody can be matched with different tense words:

### 1. Example One

### Future Tense

Sentence patterns of the future tense can be practiced by a kind folk minor, thus people can remember the sentence patterns by singing rather than by remembering. With a men-women duet mode, mutual asking melody, and humorous sentences, the folk minor is capable of allowing people to learn practical sentences happily and easily. The following sentences can be sung in “Liu Sanjie” melody.

Women (sing according to the pronunciation of Pinyin): weier a you gouyin? weier wei liugou?

(English: Where are you going? Where will you go?)

(Chinese (represented by Pinyin): ni jiang qu na li? ni jiang qu na er?)

Man (sing according to the pronunciation of Pinyin): aimu gouying tu sigu, an weiou gou tu sigu.

(English: I am going to school, I will go to school).

Woman (sing): sigu shi ge hao gu'niang, ni buneng gouyin ta.

(English: you can't delude her)

Man: you er rang a, bi gouying tu sigu shi yingyu qu xuexiao.

(English: you are wrong, be going to school is English “oing to school”)

### 2. Example Two

### Past Tense (Represented by Pinyin and English Words in all Uppercase Letters)

mei ge ren na yi ding yao lao ji, yu fa yu fa te bie rong yi ji. guo qu shi dong ci hou yao jia ed (yi di), shi (BE) dong ci HE (hei) SHE (shui) IT (ai te) yao yong WAS (wo zi). wo de dan shu di yi ren cheng ye yao yong WAS (wo zi). I (wo zi) HE (wo zi) SHE (wo zi) IT (wo zi). dan fu shu di er ren ren cheng YOU (you) he wo men (WE) jia ta (ta) men (THEY) (ri ai) tong tong du yong WERE (wo er).

guo qu shi he qi ta shi tai de guan jian qu bie shi, guo qu shi tai dong ci hou you guo qu de shi jian, ju ge li zi ni jiu ming bai liao: I FINISH MY HOMEWORK YESTERDAY (ai fei lei si de hou mu wo ke yi ai si te dai) yi si shi (wo wan cheng liao zuo tian de zuo ye. yi er san si, I WAS A STUDENT LAST YEAR (qu nian wo shi yi ge xue sheng).

### 3. Example Three

### Present Tense (Represented by Pinyin and English Words in all Uppercase Letters)

mei ge ren na yi ding yao lao ji, yu fa yu fa te bie rong yi ji. xian zai shi dong ci du yong de shi yuan xing, shi (BE) dong ci dan fu shu shi wan quan bu tong di. dan shu HE (hei) SHE (shui) IT (ai te) tong tong yong IS (ai zi), fu shu YOU (you) WE (wei) THEY (ri ai) yi ding yao yong ARE (a). ju ge li zi ni jiu ming bai liao, YOU ARE A STUDENT (ni shi xue sheng) BUT SHE IS NOT (ta bu shi). zhong wen yi si shi ni shi xue sheng, er ta bu shi bu shi (xue sheng). yi er san si, WE WORK EVERYDAY (wo men tian tian gong zuo).

### 4. Example Four

### Ongoing Tense

mei ge ren na yi ding yao lao ji, yu fa yu fa te bie rong yi ji. xian zai jM xing shi shi shi dong ci dan fu shu shi yuan xing, dong ci hou mian gen de shi ING. biao shi shi jian shi xian zai zheng zai zuo, ju ge li zi ni jiu ming bai liao, SHE IS STUDYING NOW (shui ai zi si da ying nao) (ta zheng zai xue xi), we are working (wo men zai gong zuo). yi er san si, WE ARE WORKING (wo men zai gong zuo).

### 5. Example Five

### Perfect Tense

mei ge ren na yi ding yao lao ji, yu fa yu fa to bie rong yi ji. wan cheng shi HAS HAVE hou bian gen dong fen ci, zhu yu dan fu shu yi ding yao fen qing. ju ge li zi ni jiu ming bai liao, SHE HAS BEEN TO CHINA (shui huan shi bing to qian na)(ta qu guo liao zhong guo), WE HAVE WORKED HERE (wo men yi zhi zai zhe gong zuo), yi er san si, WE′VE WORKED HERE (wo men yi zhi zai zhe li gong zuo).

In the embodiment of the present disclosure, the above word classification rules further include noting the pronunciations of the words via Chinese characters (represented by Pinyin). Examples of words are shown as follows.

1. A: arabia (alabo), apple (pingguo, pronounced as Pinyin “ai pa”), assassin (cike, as Pinyin “an sha shen”), ambulance (jiuhuche, an Pinyin “an bun eng si”), ambition (xiongxin, as Pinyin “an bi sheng”), agony (tongku, as Pinyin “ai guo ni”), abyss (shenyuan, as Pinyin “e bi si”), admire (xianmu, as Pinyin “e de ma ya”), addict (shangyin, as Pinyin “ai de ke ta”), ail (tengtong, as Pinyin “ai yo”), appall (jinghai, as Pinyin “wo pao”);

2. B: bind (bang), baby (baobao), bobble (qingyao, shiwu, loujie), bulb (pao), bar (ba), bowling (baolingqiu), band (jiebangpai, lianhe, jiehe), ballet (balei), bubble (paopaomo), bomb (bao), blog (boke), bale (zhaihuo, as Pinyin “bei ao”), bachelor (xueshi, as Pinyin “bai chi le”);

3. C: cartoon (katong), combine (jiehe, as Pinyin “kang bai yin”), cough (kesou), coffee (kafei), caffeine (kafeiyin), Cart (kache, shoutuiche), carbine (kabinqiang), cashmere (yaomaoshan, keshimi'er), casino (ducheng), chase (zhuizhu), chirp (zhazhasheng, jijisheng), combine machine (lianhe shougeji, as Pinyin “kang bai yin mai shen na”), coak (kele), calorie (kaluoli), coffin (guancai, as Pinyin “kao fen”);

4. D: daddy (diedie), ding (dingding);

5. E: engine (yinqing), economy (jingji, as Pinyin “yi kao nong min”);

6. F: fatigue (fadehen), fans (fensi), feed (fuwei de), fee (feiyong), fit (fazuo, heshi), fine (fa, fakuan), frank (fulanke), falade (ganying fadian), flee (taopao, as Pinyin “feili”);

7. G: give (geiyu), golf (gaoerfu), guitar (jita), gauche (culu de, as Pinyin “goushi”);

8. H: hormone (heermeng), hobby (hao pin), hollywood (haolaiwu), heehaw (lvjiao sheng, shaxiao, as Pinyin “hei hao”), hermit (yinshi, as Pinyin “he chu mi ta”);

9. I: I love you (wo, as Pinyin “an”);

10. J: jingo (shawenzhuyizhe, as Pinyin “jin'gong”), jack (jieke);

11. K: kowtow (koutou), kiss (qinwen, jiewen), kikini (bij i′ni);

12. L: litchi (lizhi, lizhishu), look (kan, as Pinyin “lu”), losses (sunshi, jianshao, as Pinyin “laishi”), lost (shiqu de, milu de), lynch (sixing, as Pinyin “lingchi”);

13. M: mama (mama), maze (mijing), model (mote), motor (mada), mango (mangguo), mou (mu), mould (muxing, faxing), meow (maojiaosheng, maojiao), mini (mi'ni), media (meiti), maize (yumi, as Pinyin “maizi”), mould (du de), marathon (malasong), morbid (bingtai, as Pinyin “mao bing”);

14. N: numb (mamu), Nike (naike), neon light (nihongdeng);

15. O: Olympic (aolinpike), outlets (chukou, faxie, as Pinyin “ao ta lai”), opera (yinyueju, as Pinyin “ai pu ruo”), obtuse (yuben, as Pinyin “wo bu to si”);

16. P: pingpong (pingpangqiu), pay (fukuan, as Pinyin “per”), pregnant (huaiyun, as Pinyin “pu lai ge nan de”), ponderous (feipan de), pest (haichong, “pai si ta”), putrid (fulan, as Pinyin “piao chou”);

17. Q: quick (kuai), qigong (qigong);

18. R: romantic (luomandike);

19. S: salad (shala), stone (shitou), sofa (shafa), split (silie), sand (sha), sandwich (sanmingzhi), sari/Sali/saree (shah), sue (qisu), shoot (sheji, as Pinyin “she ta”), saxophone (sakesifengguan), salon (shalong), sandstone (shashiyan), sofa (shafa), strong (qiangzhuang, as Pinyin “si zhuang”), sting (zhe, as Pinyin “si ding”), shun (shanduo, as Pinyin “shan”);

20. T: tan(shaihei, as Pinyin “tan”), tow (tuo), ton (dun), T-shirt (T-xu), tread (cai, ta), treasure (caibao, caifu, zhengcang), tyre (luntai, as Pinyin “tai”), titanic (taitan'nike), tom (tangmu), torrent (turan de), tantrum (piqi fazuo, as Pinyin “tai chun”), temper (piqi, as Pinyin “taipo”);

21. U: Ukraine (wukelan), use (yong, as Pinyin “yong si”);

22. V: vitamin (weitaming), viagra (weige, as Pinyin “wei er gang”);

23. W: waltz (huaerzi), winding (chanrao, quzhe);

24. X: XO (bailandi, as Pinyin “ai ke si ou”);

25. Y: yaw (pianhang, as Pinyin “yao”), yoo-hoo (yaohe), yo-yo (youyouqiu);

26. Z: za-zen (dachan, dazuo).

The present disclosure further provides an English training device for implenmenting the above method. The device includes:

a word classifying module, being configured for classifying and storing words according to predetermined word classification rules; and

a user command processing module, being condigured for receiving a user command for extracting a corresponding word according to a classification of the word, for extracting the corresponding word according to the user command, and for outputting the word in audio or video form.

The word classification rules include:

combining two consonants with five vowels a, e, i, o, and u respectively to form words; or

using a main word or a transformation of the main word as a main body, and combining the main body with the 26 letters of the English alphabet in sequence to form words; or

combining the five vowels a, e, i, o, and u with other letters of the English alphabet to form word roots, and combining each of the word roots with the 26 letters of the English alphabet in sequence to form words; or

matching a whole English sentence or a whole English paragraph with a Chinese song; or

noting a pronunciation of the word in the English sentence by Chinese.

Preferably, the word classification module is further configured for:

searching a database and judging whether the formed word has a basic meaning, if the formed word does not have a basic meaning, adding at least one letter of the English alphabet to the formed word or modifying at least one letter of the formed word to obtain a new word which has a basic meaning.

Preferably, the word classification module is further configured for:

connecting the whole sentence or whole paraghrap of lyrics of the song by Chinese characters to form a story.

Preferably, the word classification module is further configured for:

if the letter combined with the main body is a vowel, adding a consonant behind the vowel before the vowel is combined with the main body.

Preferably, the word classification module is further configured for:

matching the same melody with different tense words.

The English training device can be realized by computer programs. The principle of the device can be in reference to the above embodiments of the training method and details thereof are not given here any more.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. An English training method, comprising:
classifying and storing words according to predetermined word classification rules;
receiving a user command for extracting a corresponding word according to a classification of the word, and extracting the corresponding word according to the user command and outputting the word in audio or video form;
the word classification rules comprising:
combining two consonants with five vowels a, e, i, o, and u respectively to form words; or
using a main word or a transformation of the main word as a main body, and combining the main body with 26 letters of the English alphabet in sequence to form words; or
combining the five vowels a, e, i, o, and u with other letters of the English alphabet to form word roots, and combining each of the word roots with the 26 letters of the English alphabet in sequence to form words; or
matching a whole English sentence or a whole English paragraph with a Chinese song; or
noting a pronunciation of the word in the English sentence by Chinese.

2. The English training method of claim 1, wherein the step of combining two consonants with five vowels a, e, i, o, and u respectively to form words comprises:
searching a database to determine whether the formed word has a basic meaning or not; if the formed word does not have a basic meaning, adding at least one letter to the formed word or modifying at least one letter of the formed word to obtain a new word having a basic meaning.

3. The English training method of claim 1, wherein the step of matching a whole English sentence or a whole English paragraph with a Chinese song comprises:
connecting the whole English sentence or the whole English paragraph by Chinese characters to form a story.

4. The English training method of claim 1, wherein the step of using a main word or a transformation of the main word as a main body, and combining the main body with 26 letters of the English alphabet in sequence to form words comprises:
if the letter combined with the main body is a vowel, adding a consonant behind the vowel before the vowel is combined with the main body.

5. The English training method of claim 1, wherein the step of matching a whole English song or a whole English paragraph with a Chinese song comprises:
matching a same melody with different tense words.

6. An English training device, comprising:
a word classification module, being configured for classifying and storing words according to predetermined classification rules;
a user command processing module, being configured for receiving a user command for extracting a corresponding word according to a classification of the word, and extracting the corresponding word according to the user command and outputting the word in audio or video form;
the word classification rules comprises:
combining two consonants with five vowels a, e, i, o, and u respectively to form words; or
using a main word or a transformation of the main word as a main body, and combining the main body with 26 letters of the English alphabet in sequence to form words; or
combining the five vowels a, e, i, o, and u with other letters of the English alphabet to form word roots, and combining each of the word roots with the 26 English letters of the English alphabet in sequence to form words; or
matching a whole English sentence or a whole English paragraph with a Chinese song; or
noting a pronunciation of the word in the English sentence by Chinese.

7. The English training device of claim 6, wherein the word classification module is further configured for:
searching a database to determine whether the formed word has a basic meaning, and adding at least one letter to the formed word or modifying at least one letter of the formed word to obtain a new word having a basic meaning if the formed word does not have a basic meaning.

8. The English training device of claim 6, wherein the word classification module is further configured for:
connecting the whole English sentence or the whole English paragraph by Chinese characters to form a story.

9. The English training device of claim 6, wherein the word classification module is further configured for:
adding a consonant behind the vowel before the vowel is combined with the main body if the letter combined with the main body is a vowel.

10. The English training device of claim 6, wherein the word classification module is further configured for:
matching a same melody with different tense words.
